(19) United States
(12) Patent Application Publication
(10) Pub. No.: US 2023/0196729 A1
(43) Pub. Date: Jun. 22, 2023

(54) IMAGE RECOGNITION DEVICE AND IMAGE RECOGNITION METHOD

(71) Applicant: Wistron Corp., New Taipei City (TW)

(72) Inventors: Zhe-Yu LIN, New Taipei City (TW); Tay-Wey LEE, New Taipei City (TW); Zhao-Yuan LIN, New Taipei City (TW); Tsun-Hsien KUO, New Taipei City (TW); Chen Wei YANG, New Taipei City (TW)

(21) Appl. No.: 17/707,869

(22) Filed: Mar. 29, 2022

(30) Foreign Application Priority Data
Dec. 21, 2021 (TW) 110147854

(51) Int. Cl. G06V 10/764; G06T 3/40

(52) U.S. Cl. CPC G06V 10/764; G06T 3/40

(57) ABSTRACT

An image recognition method includes the following steps. An original image with a first resolution is received, and the first resolution of the original image is reduced to generate a low-resolution image with a second resolution. The first resolution is higher than the second resolution. The position of a target object in the low-resolution image is identified using an object detection model to obtain the target object coordinates in the low-resolution image. A target object image is segmented from the original image according to the target object coordinates in the low-resolution image, and the target object image is input into the image classification model. The target object type that corresponds to the target object image is determined using the image classification model.

### CROSS REFERENCE TO RELATED APPLICATIONS

This Application claims priority of Taiwan Patent Application No. 110147854, filed on Dec. 21, 2021, the entirety of which is incorporated by reference herein.

### BACKGROUND OF THE INVENTION

### Field of the Invention

The present disclosure relates to a recognition device and, in particular, to an image recognition device and image recognition method.

### Description of the Related Art

With the advancement of technology, even the mobile phones that can be seen everywhere are equipped with high-resolution cameras. So, the image resolution can be said to be a standard configuration. If the resolution is high enough, the image can be used for image recognition, and the accuracy of the image recognition can be improved.

However, when using a depth learning image recognition model, it is not easy to train image recognition models using high-resolution images. This is because the complexity of the image recognition model is also upgraded as the resolution of the hardware device is increased. If there is no corresponding arithmetic device, there will be quite some difficulty in the training of image recognition models.

Therefore, how to construct a device and method that can handle high-resolution image recognition, and enhance the accuracy of recognizing objects in the image, which has become one of the problems that need to be solved in the art.

### BRIEF SUMMARY OF THE INVENTION

In accordance with one feature of an embodiment in the present invention, the present disclosure provides an image recognition device. The image recognition device includes a processor and a storage device. The processor is configured to access the programs stored in the storage device to implement an image classification model and an object detection model, to execute the image classification model and the object detection model, wherein the processor executes the following tasks. It receives an original image with a first resolution, and reduces the first resolution of the original image to generate a low-resolution image at a second resolution, wherein the first resolution is higher than the second resolution. It identifies the position of a target object in the low-resolution image through the object detection model to obtain target object coordinates in the low-resolution image. It segments a target object image from the original image according to the target object coordinates in the low-resolution image, and inputs the target object image into the image classification model. It determines the target object type that corresponds to the target object image using the image classification model.

In one embodiment, the second resolution is ⅓-⅕ of the first resolution.

In one embodiment, the processor reduces the first resolution of the original image according to a minimum parameter acceptable by a dimension reduction encoder to generate the low-resolution image with the second resolution.

In one embodiment, the processor multiplies the coordinates of the target object in the low-resolution image by the first resolution through a conversion operation to obtain a result and divides the result by the second resolution to restore the target object in the original image.

In one embodiment, in response to the processor dividing a plurality of target object images from the original image according to the plurality of target object coordinates, the processor rotates each target object image to the same side according to the length or width, and adjusts each target object image to the same size.

In one embodiment, the processor inputs the target object images into the image classification model, and the image classification model outputs a classification result corresponding to each of the target object images.

In one embodiment, the processor adjusts the target object images to an input image size conforming to the image classification model.

In one embodiment, the processor identifies a target feature in the low-resolution image through the object detection model, and obtains the target object coordinates, a length, a width, and a target position in the low-resolution image.

In one embodiment, the processor obtains the length, the width and the target coordinates of the target object in the low-resolution image according to a target feature, so as to frame the target image of the original image.

In one embodiment, the processor identifies a target feature in the low-resolution image through the object detection model, obtains a plurality of target object coordinates in the low-resolution image according to the target feature, and the processor performs a conversion operation on each of the target object coordinates, so as to correspond each of the target object coordinates to each of a plurality of original coordinates in the original image, thereby restoring the target object image of the original image.

In accordance with one feature of an embodiment in the present invention, the present disclosure provides an image recognition method. The image recognition method includes the following steps. An original image with a first resolution is received, and the first resolution of the original image is reduced to generate a low-resolution image with a second resolution, wherein the first resolution is higher than the second resolution. The position of the target object in the low-resolution image is identified using an object detection model to obtain target object coordinates in the low-resolution image. The target object image is segmented from the original image according to the target object coordinates in the low-resolution image, and the target object image is input into the image classification model. Finally, the target object type that corresponds to the target object image is determined using the image classification model.

In one embodiment, the second resolution is ⅓-⅕ of the first resolution.

In one embodiment, the step of generating a low-resolution image with a second resolution further comprises reducing the first resolution of the original image according to the minimum parameter acceptable by a dimension reduction encoder to generate the low-resolution image with the second resolution.

In one embodiment, the image recognition method further comprises multiplying the coordinates of the target object in the low-resolution image by the first resolution through a conversion operation to obtain a result, and then dividing that result by the second resolution to restore the target object in the original image.

In one embodiment, in response to the processor dividing a plurality of target object images from the original image according to the plurality of target object coordinates, the image recognition method further comprises rotating each target object image to the same side according to the length or width, and adjusting each target object image to the same size.

In one embodiment, the image recognition method further comprises inputting the target object images into the image classification model, and outputting the image classification model by a classification result corresponding to each of the target object images.

In one embodiment, the image recognition method further comprises adjusting the target object images to an input image size that conforms to the image classification model.

In one embodiment, the processor identifies a target feature in the low-resolution image through the object detection model, and obtains the target object coordinates, a length, a width, and a target position in the low-resolution image.

In one embodiment, the image recognition method further comprises obtaining the length, the width and the target coordinates of the target object in the low-resolution image according to a target feature, so as to frame the target image of the original image.

In one embodiment, the image recognition method further comprises identifying a target feature in the low-resolution image through the object detection model, and obtaining a plurality of target object coordinates in the low-resolution image according to the target feature. The processor performs a conversion operation on each of the target object coordinates, so each of the target object coordinates corresponds to one of the original coordinates in the original image, thereby restoring the target object image of the original image.

The image recognition device and the image recognition method described in the invention reduce the dimension (reduce the resolution) of the high-resolution image to reduce the amount of computation required, and detect the target object coordinates through the object detection model, and then, they increase the dimension (increase the resolution) to obtain a high-resolution object image corresponding to the target object coordinates, and use an image classification model to determine the target object type. The accuracy rate of the object detection model and image classification model used in the invention is 94%, compared to using only a single model (such as using you only look once (YOLO) or region-based convolutional neural networks (R-CNN) object detection model) is only 75.2%. It can be seen from this that the image recognition device and the image recognition method described in the invention greatly improve the accuracy of recognizing objects in an image.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1 is a block diagram of an image recognition device in accordance with one embodiment of the present disclosure.

FIG. 2 is a flowchart of an image recognition method in accordance with one embodiment of the present disclosure.

FIG. 3 is a schematic diagram of obtaining target object coordinates of a low-resolution image in accordance with one embodiment of the present disclosure.

FIG. 4 is a schematic diagram of the restoration of the target object image in the high-resolution image in accordance with one embodiment of the present disclosure.

FIG. 5 is a schematic diagram of adjusting the target object image in the high-resolution image in accordance with one embodiment of the present disclosure.

FIG. 6 is a schematic diagram of rotating each target object image to the same long side in accordance with one embodiment of the present disclosure.

FIG. 7 is a schematic diagram of adjusting each target object image to the same size in accordance with one embodiment of the present disclosure.

FIG. 8 is a schematic diagram of determining the target object type corresponding to the target object images S1-S3 using the image classification model 30 in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention is described with respect to particular embodiments and with reference to certain drawings, but the invention is not limited thereto and is only limited by the claims. It will be further understood that the terms “comprises,” “comprising,” “includes” and/or “including,” in response to used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

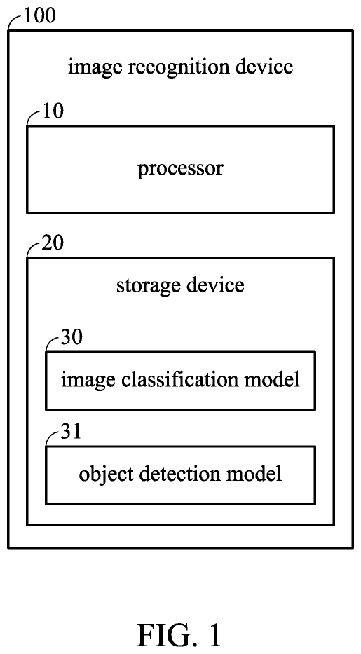

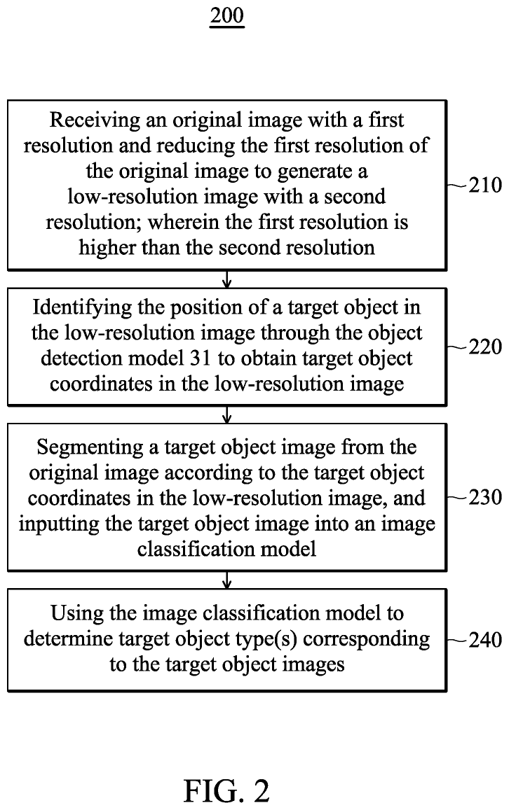

Please refer to FIGS. 1-2, FIG. 1 is a block diagram of an image recognition device 100 in accordance with one embodiment of the present disclosure. FIG. 2 is a flowchart of an image recognition method 200 in accordance with one embodiment of the present disclosure. In one embodiment, the image recognition method 200 can be implemented using the image recognition device 100.

As shown in the FIG. 1, the image recognition device 100 can be a desktop computer, notebook or a virtual machine for the architecture on the host operation system.

In one embodiment, the function of the image recognition apparatus 100 can be implemented by hardware circuit, wafer, firmware or software.

In one embodiment, the image recognition device 100 includes a processor 10 and a storage device 20. In one embodiment, the image recognition device 100 further includes a display (not shown in the figures).

In one embodiment, the processor 10 can be implemented using an integrated circuit such as a micro controller, a microprocessor, a Digital Signal Processor (DSP), a Field Programmable Gate Array (FPGA), an Application Specific Integrated Circuit (ASIC), or a logic circuit.

In one embodiment, the storage device 20 can be realized by read-only memory, flash memory, floppy disk, hard disk, optical disk, flash drive, tape, network accessible database or storage medium with the same function.

In one embodiment, the processor 10 is used to access the program stored in the storage device 20 to implement the image recognition method 200.

In one embodiment, the image classification model 30 can be implemented by a known convolution neural network (CNN), or other image classification neural network that can be used to classify images.

In an embodiment, the object detection model 31 can be implemented by known YOLO (you only look once) algorithm or Faster Region-Based Convolutional Neural Networks (faster RCNN).

In one embodiment, the function of the image classification model 30 and the object detection model 31 stored in the storage device 20 can be implemented by hardware (circuit/wafer), software or firmware.

In one embodiment, the image classification model 30 and the object detection model 31 can be implemented by a software or firmware stored in the storage device 20. The image recognition device 100 transmits the image classification model 30 and the object detection model 31 stored in the storage device 20 through the processor 10 to implement the function of the image recognition device 100.

The image recognition method 200 is described by the FIG. 2.

In step 210, the processor 10 receives an original image with a first resolution and reduces the first resolution of the original image to generate a low-resolution image with a second resolution, and the first resolution is higher than the second resolution.

In one embodiment, the original image is 3000*4000 pixels (first resolution), the maximum image size of the object detection model can be trained to be 832*832 pixels (second resolution). The first resolution is higher than the second resolution. However, here is only one example, the size of the first resolution and the second resolution is not limited thereto.

In one embodiment, the original image includes multiple subject matters. In an embodiment, the subject matter is, for example, wiggler or other object to be identified.

In one embodiment, the image of the subject matter is collected from the Health Bureau, and the target object of the subject matter is labeled, for example, aedes mosquito or house mosquito, to train image classification model 30 and object detection model 31.

In one embodiment, the deep learning object detection model 31 can be implemented by models such as YOLO or Faster RCNN. Taking the GTX 1080 Graphics Processing Unit (GPU) computing device to train the model, in order to maintain a certain batch size of model accuracy, the maximum image size that this object detection model can train is about 832*832 (pixels). If the pixels of the original image are 3000*4000, and the object detection model 31 is directly used for object detection, the high-resolution original image (the first-resolution image) must be reduced to a lower-resolution image (the second-resolution image) for model training, but the advantage of the original image being a high-resolution image is lost. Although the target object can be identified from the original image, the characteristics of the target object will become blurred due to the reduced resolution, making it difficult to identify the type of the target.

Therefore, a subsequent step needs to be performed, through the processor 10 applying the object detection model 31 and the low-resolution image to identify the target object image in the original image of the high-resolution image. And, according to the target object images, the corresponding target object types are classified.

Accordingly, the processor 10 reduces the first resolution of the original image to generate a low-resolution image with the second resolution.

In one embodiment, the second resolution is ⅓-⅕ of the first resolution.

In one embodiment, the processor 10 reduces the first resolution of the original image according to a minimum parameter acceptable to a dimensionality reduction encoder to generate a low-resolution image with a second resolution. For example, the maximum image size that can be accepted by the operation model (referred to as the object detection model 31) of the graphics processing of the GTX 1080 is about 832*832 (pixels), then the processor 10 uses the dimensionality reduction encoder to convert the image pixels to 832*832 is regarded as the lowest parameter, and the first resolution of the original image is reduced accordingly (for example, the image pixels of the original image are 3000*4000) to the image pixels of 832*832, so as to generate a low-resolution image with the second resolution (image pixels 832*832).

Among them, the dimensionality reduction encoder can apply by the known missing value ratio, low variance filter, high correlation filter, random forest, principal component analysis (PCA), backward feature elimination, forward feature construction, or other algorithms that can reduce the dimension of the image to achieve it.

Therefore, the low-resolution image generated by the dimensionality reduction encoder can be directly input to the object detection model 31.

In step 220, the processor 10 identifies the position of a target object in the low-resolution image through the object detection model 31 to obtain target object coordinates in the low-resolution image.

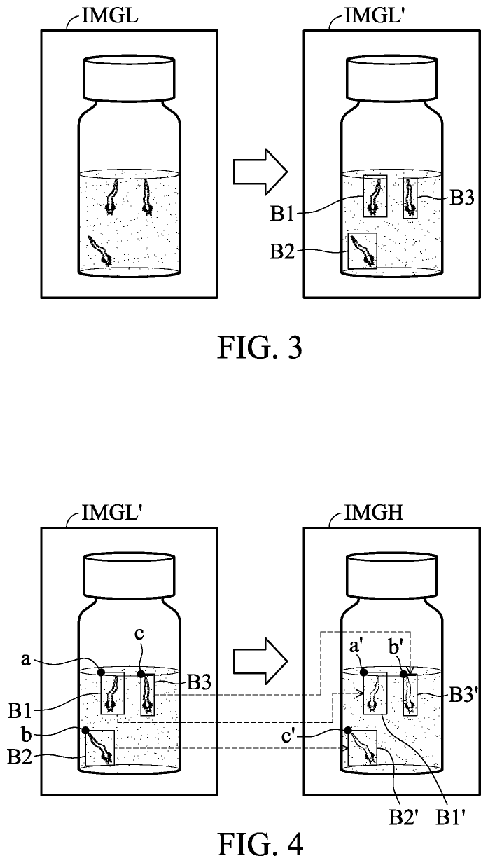

Please refer to FIG. 3, FIG. 3 is a schematic diagram of obtaining target object coordinates of a low-resolution image in accordance with one embodiment of the present disclosure. In FIG. 3, the processor 10 identifies the position of a target object in the low-resolution image IMGL through the object detection model 31, thereby obtaining the target object coordinates of a low-resolution image IMGL. After the target object coordinates are known, the position of the target object can be selectively framed (that is, the frame selection blocks B1-B3 in the low-resolution image IMGL′).

In one embodiment, the processor 10 identifies a target feature in the low-resolution image IMGL through the object detection model 31, and obtains the target object coordinates, a length, a width and a target position in the low-resolution image IMGL according to the target feature. The target object position in the low-resolution image IMGL can be calculated.

In one embodiment, the processor 10 identifies an object feature in the low-resolution image IMGL through the object detection model 31. The processor 10 obtains a plurality of target object coordinates (e.g., four) of the target object position in the low-resolution image IMGL according to the target feature, and then directly obtains the target object position in the low-resolution image IMGL.

Thereby, the low-resolution image IMGL is used as the input of the object detection model 31, and the object detection model 31 is used to detect the target object position. The object detection model 31 is such as YOLO, region-based convolutional neural networks (RCNN), etc., but is not limited to these types of models. The model can be trained by a large number of marked target object images in advance. Since the features of the target object still exist on the low-resolution image IMGL, even the low-resolution image IMGL can still directly identify the target object position. The label used for the object detection model 31 can use an image marked with a frame, the coordinate position or coverage of the target object as the label.

In step 230, the processor 10 segments a target object image from the original image according to the target object coordinates in the low-resolution image, and the processor 10 inputs the target object image into an image classification model.

Please refer to FIG. 4. FIG. 4 is a schematic diagram of the restoration of the target object image in the high-resolution image IMGH in accordance with one embodiment of the present disclosure.

In one embodiment, the processor 10 identifies a target feature in the low-resolution image IMGL through the object detection model 31, and obtains a plurality of object coordinates a-c in the low-resolution image IMGL′ according to the target feature, each of these target object coordinates a-c is subjected to a conversion operation to correspond these target object coordinates a-c to a plurality of original coordinates a′-c′ in the original image (i.e., the high-resolution image IMGH). Thereby, the target object image of the original image IMGH is restored.

In one embodiment, the processor 10 restores the target object image in the high-resolution image IMGH through a conversion operation.

In one embodiment, the calculation method of the conversion operation is: multiplying the target object coordinates in the low-resolution image IMGL′ by the resolution (first resolution) of the high-resolution image IMGH to generate a result. The result is then divided by the resolution (second resolution) of the low-resolution image IMGL to restore the target image of the high-resolution image IMGH.

In one embodiment, an example of the calculation method of the conversion operation is: the target object coordinates detected on the low-resolution image (832*832) are (416, 416), and the coordinates of frame length are (32, 32), after converting to percentage, the coordinates are (50, 50), the coordinates of frame length are (3.84, 3.84), then converting the coordinates on the high-resolution image to (2000, 1500), and the coordinates of frame length are (153, 115). The operation is as follows:

(X,Y)_{high}=(X,Y)_{low}*HighR/LowR

The symbol HighR is the resolution of the original image, the symbol LowR is the resolution of the low-resolution image, the symbol (X,Y)_{low} is the target object coordinates or frame length detected on the low-resolution image, and the symbol (X,Y)_{high} is the coordinate position or frame length of the target object image on the high-resolution image.

In one embodiment, the origin of coordinates the low-resolution image IMGL and the original image (i.e., the high-resolution image IMGH) are defined as the same, for example, the upper left corner is defined as (0, 0).

In one embodiment, the processor 10 obtains the coordinates, length, and width of the target object in the low-resolution image IMGL according to a target feature, so as to frame the target object image of the original image IMGH.

In one embodiment, the processor 10 obtains the coordinates, lengths, and widths of multiple target objects in the low-resolution image IMGL according to a target feature, so as to frame and select multiple object images of the original image IMGH (i.e., the frame selection blocks B1′-B3′ in the original image IMGH). In other words, the processor 10 can map the frame selection blocks B1-B3 in the low-resolution image IMGL′ to the frame selection blocks B1′-B3′ in the original image IMGH through the conversion operation. At the same time, the processor 10 obtains the respective vertex coordinates of the frame selection blocks B1-B3 and B1′-B3′ through a conversion operation, so that these blocks can be selectively displayed (or not displayed) on a display.

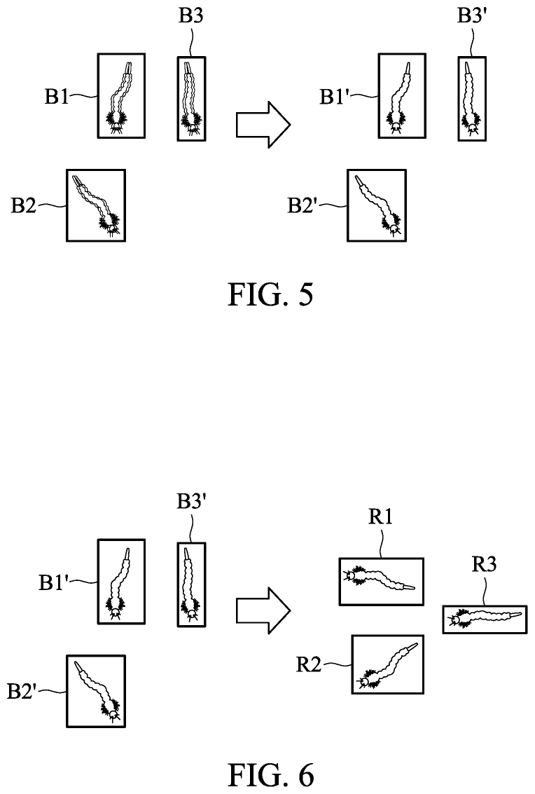

Please refer to FIG. 5. FIG. 5 is a schematic diagram of adjusting the target object image in the high-resolution image IMGH in accordance with one embodiment of the present disclosure. In FIG. 5, for the convenience of description, the frame selection blocks B1-B3, B1′-B3′ are regarded as the target object image, and FIG. 5 shows the frame selection blocks B1-B3, B1′-B3′ in FIG. 4 are independently cut out.

As can be seen from FIG. 5, the resolutions of the frame selection blocks B1 to B3 are lower than the resolutions of the frame selection blocks B1′ to B3′. The target object images in the frame selection blocks B1′-B3′ is relatively clear.

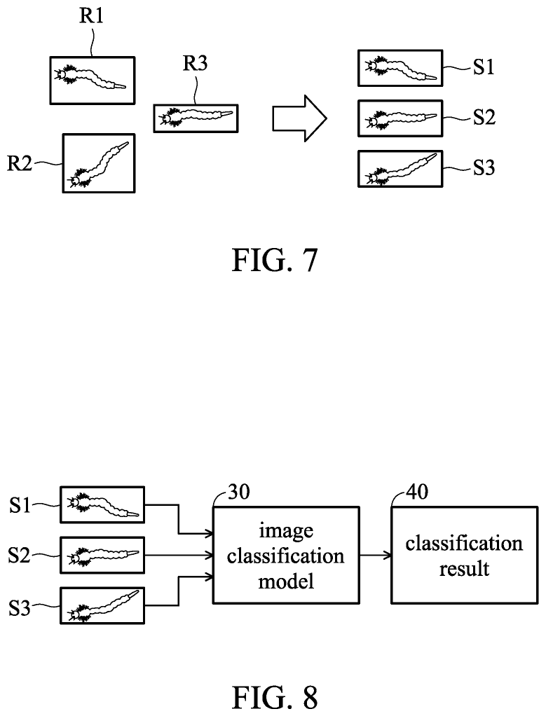

Please refer to FIGS. 6-7. FIG. 6 is a schematic diagram of rotating each target object image B1′-B3′ to the same long side in accordance with one embodiment of the present disclosure. FIG. 7 is a schematic diagram of adjusting each target object image B1′-B3′ to the same size in accordance with one embodiment of the present disclosure.

In one embodiment, when the processor 10 divides a plurality of target object images B1′-B3′ from the original image IMGH according to the plurality of target object coordinates, and converts each target object image B1′-B3′ according to the length to the same side (for example, as shown in FIG. 6, the processor 10 rotates the target object images B1′ to B3′ to the same long side, and obtains the rotated target object images R1 to R3. The target object image B1′ corresponds to the rotated target object image R1, target object image B2′ corresponds to rotated target image R2, target object image B3′ corresponds to rotated target image R3) and adjusts each target object image R1-R3 to the same size (for example, as shown in FIG. 7, each target object image R1-R3 is adjusted to the same size, and the resized target object images S1-S3 are obtained. The target object image R1 corresponds to the rotated target object image S1, and the target object image R2 corresponds to the rotated target image S2, and the target object image R3 corresponds to the rotated target image S3).

In one embodiment, when the processor 10 divides the original image IMGH into a plurality of target object images B1′-B3′ according to the plurality of target object coordinates and rotates each target object image B1′-B3′ according to the width to the same side.

In one embodiment, as shown in FIG. 7, the processor 10 adjusts the target object images R1-R3 rotated to the same long side to conform to an input image size of the image classification model 30, that is, the target object images S1-S3.

In step 240, the processor 10 uses the image classification model 30 to determine target object type(s) corresponding to the target object images S1-S3.

Please refer to FIG. 8, which is a schematic diagram of determining the target object type that corresponds to the target object images S1-S3 using the image classification model 30 in accordance with one embodiment of the present disclosure.

In one embodiment, as shown in FIG. 8, the processor 10 inputs the target object images S1-S3 into the image classification model 30, and the image classification model 30 outputs a classification result 40 corresponding to each of the target object images S1-S3.

In one embodiment, the classification result 40 can be a target object type, such as zebra or mosquito.

In one embodiment, the target can be, for example, a wiggler (a mosquito larvae). The body structure of mosquitoes includes head, chest, chest hair, body, and breathing tube. The breathing tube of the aedes mosquito is characterized by a short, thick, vertical state, and the thorax is narrower and less hairy. The breathing tube of the house mosquito is characterized by a thin, long, 45-degree angle, and a broad, hairy thorax. In one embodiment, the image classification model 30 can determine that the each of target object images S1 to S3 is larvae of aedes mosquito or house mosquito according to these features.

It can be seen from the above that in step 240, the captured high-resolution image of the target object images can be trained by the image classification model 30. However, because the size of each target object is different, before training the image classification model 30, it is necessary to simultaneously scale each target object image to a uniform size for training In order to avoid excessive distortion of the image after scaling to a uniform size, the image is first rotated to the uniform long side (or uniform wide side), then scaled, and finally input to the image classification model 30. The final output result is to determine the category (e.g., aedes mosquito or house mosquito) with a single target object image as a unit. The image classification model 30 can be a deep learning network such as VGG, Resnet, Densenet, etc., but is not limited thereto.

After the training of the image classification model 30 is completed, the processor 10 uses the image classification model 30 to determine the target object type that corresponds to each target object image S1-S3.

In one embodiment, the target object type refers to the larvae of aedes mosquito or house mosquito, and the image classification model 30 can output the mosquito classification corresponding to the target object images S1-S3. For example, the image classification model 30 outputs the target object images S1 and S2 as house mosquito, and outputs the target object image S3 as aedes mosquito.

In one embodiment, the target object type refers to the larvae of aedes mosquito or house mosquito, and the image classification model 30 can output the probability of mosquito classification corresponding to each of the target object images S1-S3. For example, the image classification model 30 outputs the target object image S1 with a 90% probability of being aedes mosquito, a 5% probability of being aedes mosquito, and the classification result 40 is aedes mosquito (because the probability of aedes mosquito is higher). The image classification model 30 outputs the target object image S2 with a 95% probability of being aedes mosquito, a 3% probability of being aedes mosquito, and the classification result 40 is aedes mosquito (because the probability of aedes mosquito is higher). The image classification model 30 outputs the target object image S3 with a 10% probability of being aedes mosquito, a 97% probability of being aedes mosquito, and the classification result 40 is aedes mosquito (because the probability of aedes mosquito is higher).

In some embodiments, the classification result 40 is stored in the storage device 20, but not limited thereto. In some embodiments, the classification result 40 is displayed on a display device, but not limited thereto. In some embodiments, the classification result 40 is transmitted to an external electronic device (a server or a mobile device) through a communication device, but not limited thereto.

The image recognition device and the image recognition method described in this case are not limited to being used in classifying aedes mosquito or house mosquito. The above is only an example. The image recognition device and image recognition method described in the invention are suitable for classifying objects in various images, for example, roses or lilies (categories of flowers), huskies or Shiba Inu (categories of dogs), cars or buses (categories of vehicles), etc. As long as the objects in the image can be classified.

The image recognition device and the image recognition method described in the invention reduce the dimension (reduce the resolution) of the high-resolution image to reduce the amount of computation, and detect the target object coordinates through the object detection model, and then, increase the dimension (increase the resolution) to obtain a high-resolution object image corresponding to the target object coordinates, and use an image classification model to determine the target object type. The accuracy rate of the object detection model and image classification model used in the invention is 94%, compared to using only a single model (such as using you only look once (YOLO) or region-based convolutional neural networks (R-CNN) object detection model) is only 75.2%. It can be seen from this that the image recognition device and the image recognition method described in the invention greatly improve the accuracy of recognizing objects in an image.

The methods of the present invention, or specific versions or portions thereof, may exist in the form of code. The code may be contained in physical media, such as floppy disks, optical discs, hard disks, or any other machine-readable (such as computer-readable) storage media, or not limited to external forms of computer program products. When the code is loaded and executed by a machine, such as a computer, the machine becomes a device for participating in the present invention. The code may also be transmitted through some transmission medium, such as wire or cable, optical fiber, or any type of transmission, wherein when the code is received, loaded, and executed by a machine, such as a computer, the machine becomes used to participate in the invented device. When implemented on a general-purpose processing unit, the code in conjunction with the processing unit provides a unique device that operates similarly to application-specific logic circuits.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. An image recognition device, comprising:
a processor; and
a storage device, wherein the processor is configured to access the programs stored in the storage device to implement an image classification model and an object detection model, to execute the image classification model and the object detection model, wherein the processor:
receives an original image with a first resolution, and reduces the first resolution of the original image to generate a low-resolution image with a second resolution, wherein the first resolution is higher than the second resolution;
identifies the position of a target object in the low-resolution image using the object detection model to obtain target object coordinates in the low-resolution image;
segments a target object image from the original image according to the target object coordinates in the low-resolution image, and inputs the target object image into the image classification model; and
determines a target object type corresponding to the target object image using the image classification model.

2. The image recognition device of claim 1, wherein the second resolution is ⅓-⅕ of the first resolution.

3. The image recognition device of claim 1, wherein the processor reduces the first resolution of the original image according to a minimum parameter acceptable by a dimension reduction encoder to generate the low-resolution image with the second resolution.

4. The image recognition device of claim 1, wherein the processor multiplies the coordinates of the target object in the low-resolution image by the first resolution through a conversion operation to obtain a result and divides the result by the second resolution to restore the target object in the original image.

5. The image recognition device of claim 1, wherein in response to the processor dividing a plurality of target object images from the original image according to the plurality of target object coordinates, the processor rotates each target object image to the same side according to the length or width, and adjusts each target object image to the same size.

6. The image recognition device of claim 5, wherein the processor inputs the target object images into the image classification model, and the image classification model outputs a classification result corresponding to each of the target object images.

7. The image recognition device of claim 5, wherein the processor adjusts the target object images to an input image size conforming to the image classification model.

8. The image recognition device of claim 1, wherein the processor identifies a target feature in the low-resolution image through the object detection model, and obtains the target object coordinates, a length, a width, and a target position in the low-resolution image.

9. The image recognition device of claim 8, wherein the processor obtains the length, the width and the target coordinates of the target object in the low-resolution image according to a target feature, so as to frame the target image of the original image.

10. The image recognition device of claim 1, wherein the processor identifies a target feature in the low-resolution image through the object detection model, obtains a plurality of target object coordinates in the low-resolution image according to the target feature, and the processor performs a conversion operation on each of the target object coordinates, so as to correspond each of the target object coordinates to each of a plurality of original coordinates in the original image, thereby restoring the target object image of the original image.

11. An image recognition method, comprising:
receiving an original image with a first resolution, and reducing the first resolution of the original image to generate a low-resolution image with a second resolution, wherein the first resolution is higher than the second resolution;
identifying the position of a target object in the low-resolution image through an object detection model to obtain target object coordinates in the low-resolution image;
segmenting a target object image from the original image according to the target object coordinates in the low-resolution image, and inputting the target object image into the image classification model; and
determining the target object type corresponding to the target object image using an image classification model.

12. The image recognition method of claim 11, wherein the second resolution is ⅓-⅕ of the first resolution.

13. The image recognition method of claim 11, wherein the step of generating a low-resolution image with a second resolution further comprises:
reducing the first resolution of the original image according to a minimum parameter acceptable by a dimension reduction encoder to generate the low-resolution image with the second resolution.

14. The image recognition method of claim 11, further comprising:
multiplying the coordinates of the target object in the low-resolution image by the first resolution through a conversion operation to obtain a result and dividing the result by the second resolution to restore the target object in the original image.

15. The image recognition method of claim 11, wherein in response to the processor dividing a plurality of target object images from the original image according to the plurality of target object coordinates, the image recognition method further comprises:
rotating each target object image to the same side according to the length or width, and adjusting each target object image to the same size.

16. The image recognition method of claim 15, further comprising:
inputting the target object images into the image classification model, and
outputting the image classification model according to a classification result corresponding to each of the target object images.

17. The image recognition method of claim 15, further comprising:
adjusting the target object images to an input image size conforming to the image classification model.

18. The image recognition method of claim 11, wherein the processor identifies a target feature in the low-resolution image through the object detection model, and obtains the target object coordinates, a length, a width, and a target position in the low-resolution image.

19. The image recognition method of claim 18, further comprising:
obtaining the length, the width and the target coordinates of the target object in the low-resolution image according to a target feature, so as to frame the target image of the original image.

20. The image recognition method of claim 11, further comprising:
identifying a target feature in the low-resolution image through the object detection model; and
obtaining a plurality of target object coordinates in the low-resolution image according to the target feature, and the processor performs a conversion operation on each of the target object coordinates, so as to correspond each of the target object coordinates to each of a plurality of original coordinates in the original image, thereby restoring the target object image of the original image.
